(19) United States
(12) Patent Application Publication
(10) Pub. No.: US 2024/0275888 A1
(43) Pub. Date: Aug. 15, 2024

(54) INSPECTION APPARATUS, IMAGE FORMING APPARATUS, CONTROL METHOD OF INSPECTION APPARATUS, AND STORAGE MEDIUM

(71) Applicant: CANON KABUSHIKI KAISHA, Tokyo (JP)

(72) Inventor: RYO KAZUMI, Kanagawa (JP)

(21) Appl. No.: 18/439,302

(22) Filed: Feb. 12, 2024

(30) Foreign Application Priority Data
Feb. 15, 2023 (JP) 2023-021553

(51) Int. Cl. H04N 1/00

(52) U.S. Cl. CPC H04N 1/00005; H04N 1/00015; H04N 1/00039; H04N 1/00045; H04N 1/00066

(57) ABSTRACT

An inspection apparatus includes: a setting unit configured to set a type of inspection to be performed on code images in a print product in which the code images are printed, for each of inspection regions including the code images being inspection targets; an obtaining unit configured to obtain a read image obtained by reading the print product; and an inspection unit configured to perform the type of inspection set by the setting unit for each of the inspection regions in the read image, in which the type of inspection includes a first type of inspection and a second type of inspection, the second type of inspection including more inspection items than the first type of inspection.

### BACKGROUND

### Field

The present disclosure relates to a technique of inspecting a print product.

### Description of the Related Art

A method of inspecting a code image such as a barcode included in a print product is known. Japanese Patent Laid-Open No. 2015-212873 discloses performing both of: processing of extracting a code image from a read image of a print product and decoding the extracted code image; and quality evaluation processing of performing inspection by evaluating presence or absence of a defect in the extracted code image or the like.

The inspection of the print product normally needs to be completed within predetermined time. For example, in an inline inspection in which the print product is inspected in a period from printing of an image on a paper sheet to discharging of the print product, the inspection needs to be completed within conveyance time from the printing to the discharging of the print product. If the inspection of quality evaluation is always performed on all code images in the print product as in the inspection method of Japanese Patent Laid-Open No. 2015-212873, completing the inspection of the print product within the predetermined time is difficult in some cases such as the case where many code images are present in the print product.

### SUMMARY

An inspection apparatus according to embodiments of the present disclosure includes: a setting unit configured to set a type of inspection to be performed on code images in a print product in which the code images are printed, for each of inspection regions including the code images being inspection targets; an obtaining unit configured to obtain a read image obtained by reading the print product; and an inspection unit configured to perform the type of inspection set by the setting unit for each of the inspection regions in the read image, in which the type of inspection includes a first type of inspection and a second type of inspection, the second type of inspection including more inspection items than the first type of inspection.

Further features of the present disclosure will become apparent from the following description of exemplary embodiments with reference to the attached drawings.

### BRIEF DESCRIPTION OF THE DRAWINGS

FIG. 1 is an overall diagram for explaining a configuration of a print inspection system.

FIG. 2 is a diagram showing the relationship of FIG. 2A and FIG. 2B.

FIG. 2A is a block diagram for explaining control configurations of apparatuses forming the print inspection system.

FIG. 2B is a block diagram for explaining control configurations of apparatuses forming the print inspection system.

FIG. 3 is a mechanical cross-sectional diagram expressing an overview configuration of an image forming apparatus.

FIG. 4 is a block diagram illustrating a functional arrangement of an inspection apparatus.

FIG. 5 is a flowchart for explaining a flow from registration processing of a reference image to execution of inspection.

FIG. 6 is a diagram for explaining a grade measured by a grade inspection.

FIG. 7 is a diagram illustrating an example of an inspection setting screen.

FIG. 8 is a flowchart for explaining details of registration processing of inspection settings.

FIG. 9 is a flowchart for explaining details of processing of receiving input in an inspection content setting region.

FIG. 10 is a diagram showing the relationship of FIG. 10A and FIG. 10B.

FIG. 10A is a flowchart for explaining details of inspection processing.

FIG. 10B is a flowchart for explaining details of inspection processing.

FIG. 11 is a flowchart for explaining a grade inspection for an inspection region being an inspection target.

FIG. 12 is a flowchart for explaining a decoding inspection for the inspection region being the inspection target.

FIG. 13 is a diagram illustrating an example of the inspection setting screen.

FIG. 14 is a flowchart for explaining the grade inspection performed on the inspection region being the inspection target.

### DESCRIPTION OF THE EMBODIMENTS

Embodiments of the technique of the present disclosure are described below by using the drawings. Note that the following embodiments do not limit the technique according to the scope of claims, and not all of combinations of features described in the following embodiments are necessarily essential for solving means of the technique of the present disclosure.

### First Embodiment

### [System Configuration]

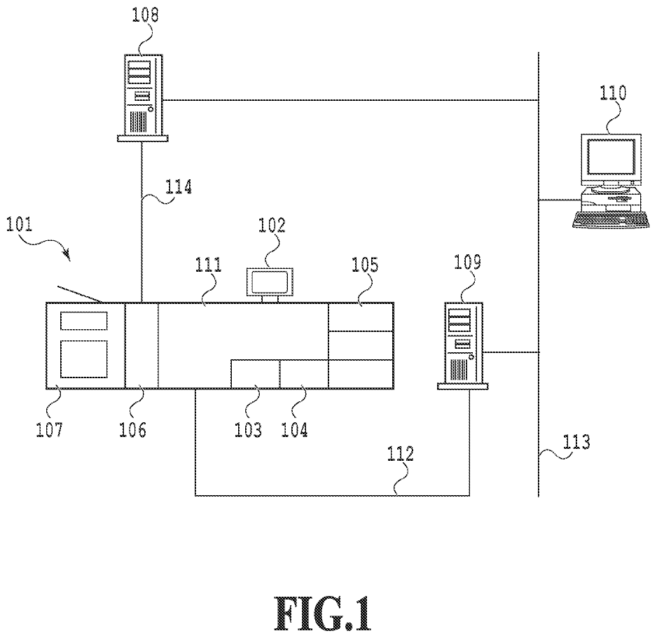

FIG. 1 is an overall diagram for explaining a configuration of a print inspection system in the present embodiment. The print inspection system of the present embodiment includes an information processing apparatus 109, an inspection apparatus 108, and an image forming apparatus 101. The image forming apparatus 101 and the information processing apparatus 109 are connected to each other via a cable 112. The information processing apparatus 109, a client computer 110, and the inspection apparatus 108 are connected to one another via a network 113.

The image forming apparatus 101 includes a print unit 111, an inspection unit 106, and a large-capacity stacker 107. The image forming apparatus 101 of the present embodiment is formed of devices with multiple varying functions, and is configured to be capable of performing complex print processing such as bookbinding.

The print unit 111 includes an UI panel 102 and paper feed decks 103 and 104, and an option deck 105 formed of three stages of paper feed decks is connected to the print unit 111. The UI panel 102 is, for example, a user interface including a capacitance type touch panel. Description is given assuming that the print unit 111 of the present embodiment is a print device including an electrophotographic printer. However, the print unit 111 may be a print device including a printer of another type such as an inkjet type or an offset type.

The print unit 111 prints an image on a paper sheet that is a conveyed print medium, based on a print job. The print job is transmitted from the information processing apparatus 109 to the print unit 111 via the cable 112.

A printer driver having a function of converting print data to a print description language processable by the information processing apparatus 109 is installed in the client computer 110. A user who instructs printing can generate the print job including in the print data from various applications via the printer driver. The generated print job is transmitted to the information processing apparatus 109 via the network 113, and is managed in the information processing apparatus 109. Note that a form of the print job may be such that the print job is generated in the information processing apparatus 109 and managed in the image forming apparatus 101.

In the case where the information processing apparatus 109 receives the print instruction from the client computer 110, the information processing apparatus 109 performs data analysis and rasterization processing on the print data included in the print job, inputs the processed print data into the print unit 111, and instructs the print unit 111 to perform printing.

The inspection unit 106 reads the paper sheet (print product) subjected to the print processing in the print unit 111, and transmits a read image obtained as a result of this reading to the inspection apparatus 108 connected via a cable 114.

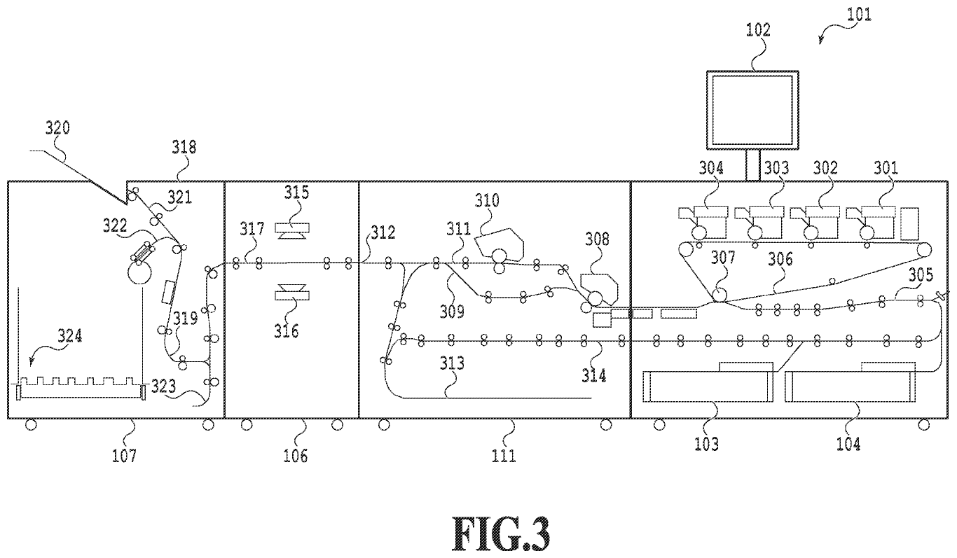

The inspection apparatus 108 is an inspection apparatus for inspecting whether the printed image is normal (has no defects) or not and for similar inspections. Details of the inspection are described later. The large-capacity stacker 107 includes a main tray 324 (see FIG. 3) and a top tray 320 (see FIG. 3). Several thousands of paper sheets can be stacked at once on the main tray 324.

The connection methods of the image forming apparatus 101, the information processing apparatus 109, and the client computer 110 illustrated in FIG. 1 are examples, and various other connection methods can be applied. For example, the print inspection system may be configured such that the client computer 110, the information processing apparatus 109, and the inspection apparatus 108 are connected to the image forming apparatus 101 by the cable 112 to be capable of communicating with the image forming apparatus 101.

### [About Control Configuration of Print Unit in Image Forming Apparatus]

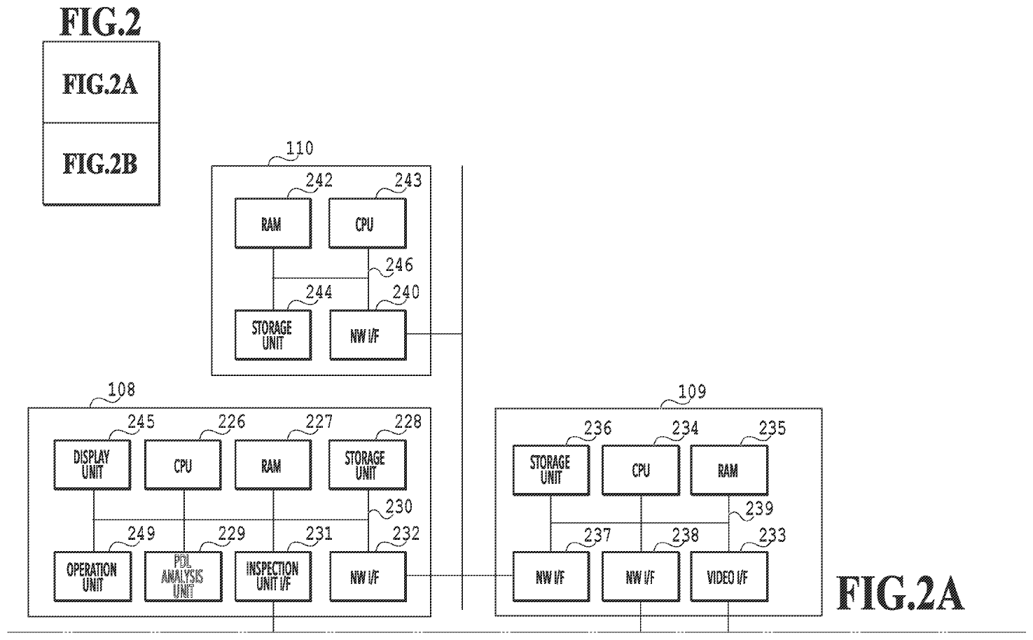

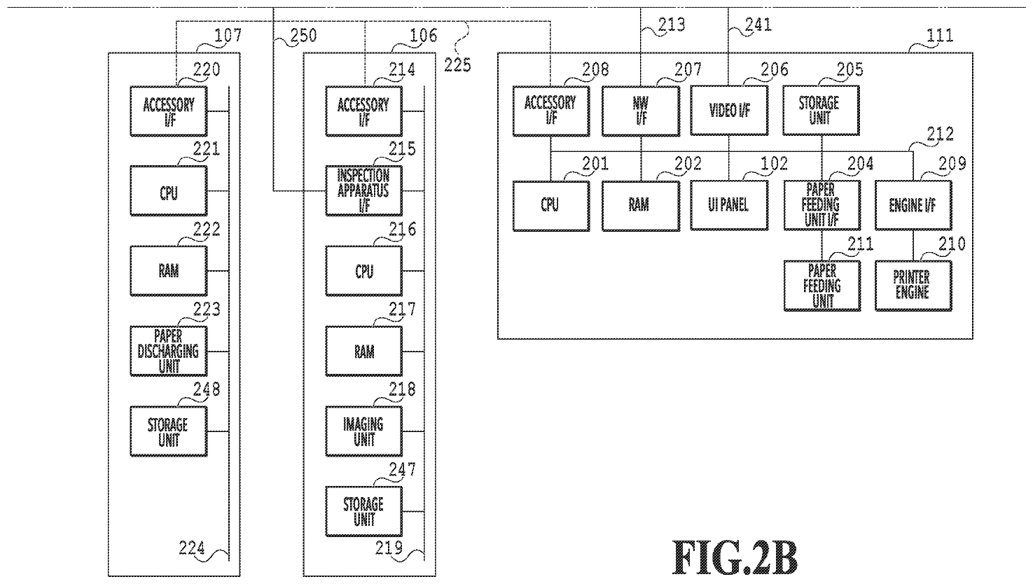

FIGS. 2A and 2B are block diagrams for explaining control configurations of units included in the image forming apparatus 101, the inspection apparatus 108, the large-capacity stacker 107, the information processing apparatus 109, and the client computer 110 forming the print inspection system of the present embodiment.

The print unit 111 of the image forming apparatus 101 includes a CPU 201, a RAM 202, the UI panel 102, a paper feeding unit I/F 204, a storage unit 205, a video I/F 206, an NW I/F 207, an accessory I/F 208, and an engine I/F 209. The print unit 111 also includes a printer engine 210 and a paper feeding unit 211. These components are connected to one another via a system bus 212.

The central processing unit (CPU) 201 performs computation and control of the units in the image forming apparatus 101 via the system bus 212. Moreover, the CPU 201 executes a program stored in the storage unit 205 by loading the program onto the random access memory (RAM) 202. The RAM 202 is one type of general volatile memory that can be directly accessed by the CPU 201, and is used as a work area of the CPU 201 or as other temporal data storage areas. The storage unit 205 also functions as the temporal storage areas and the work memory in the operation of the print unit 111.

The engine I/F 209 communicates with the printer engine 210, and controls the printer engine 210. The paper feeding unit I/F 204 communicates with the paper feeding unit 211, and controls the paper feeding unit 211. The paper feed decks 103 and 104 and the option deck 105 are included in the paper feeding unit 211.

The UI panel 102 is a user interface used to perform operations on the image forming apparatus 101 in general. In the image forming apparatus 101, the CPU 201 receives input made by the user, and performs display of a state of printing or the apparatus and the like through the UI panel 102.

The network interface (NW I/F) 207 is connected to a NW I/F 238 of the information processing apparatus 109 via a cable 213. The NW I/F 207 performs communication between the information processing apparatus 109 and the image forming apparatus 101.

FIGS. 2A and 2B illustrate a configuration in which the NW I/F 207 connected to the system bus 212 in the print unit 111 of the image forming apparatus 101 is directly connected to the NW I/F 238 connected to a system bus 239 in the information processing apparatus 109. Alternatively, the information processing apparatus 109 and the image forming apparatus 101 may be connected by, for example, a network or the like, and the form of connection between the information processing apparatus 109 and the image forming apparatus 101 is not limited to a particular form.

The video I/F 206 is connected to a video I/F 233 of the information processing apparatus 109 via a video cable 241, and performs communication of image data between the information processing apparatus 109 and the image forming apparatus 101. A connection interface with the information processing apparatus 109 in the image forming apparatus 101 may employ a form in which the functions of the NW I/F 207 and the video I/F 206 are integrated. In this case, a connection interface with the image forming apparatus 101 in the information processing apparatus 109 may employ a form in which the functions of the NW I/F 238 and the video I/F 233 are integrated.

The accessory I/F 208 is connected to an accessory I/F 214 of the inspection unit 106 and an accessory I/F 220 of the large-capacity stacker 107 via a cable 225. The print unit 111, the inspection unit 106, and the large-capacity stacker 107 communicate with one another via the accessory I/Fs 208, 214, and 220 thereof.

### [About Control Configuration of Inspection Unit in Image Forming Apparatus]

The inspection unit 106 of the image forming apparatus 101 includes the accessory I/F 214, an inspection apparatus I/F 215, a CPU 216, a RAM 217, an imaging unit 218, and a storage unit 247. These components are connected to one another by a system bus 219.

The CPU 216 performs computation and control of the units in the inspection unit 106 via the system bus 219. Moreover, the CPU 216 executes a program stored in the storage unit 247 by loading the program onto the RAM 217. The RAM 217 is a general volatile memory that can be directly accessed by the CPU 216, and is used as a work area of the CPU 216 or as other temporal data storage areas. The storage unit 247 also functions as the temporal storage areas and the work memory in the operation of the inspection unit 106.

The inspection apparatus I/F 215 is connected to an inspection unit I/F 231 of the inspection apparatus 108 via a cable 250. The inspection unit 106 is configured to be capable of communicating with the inspection apparatus 108 via the inspection apparatus I/F 215 and the inspection unit I/F 231.

The imaging unit 218 is a reading unit of the paper sheets in which contact image sensors (hereinafter, CISs) are mounted and that has an imaging function. The imaging unit 218 can image the paper sheets (print products) subjected to print processing and passing inside the inspection unit 106. The read images obtained by the imaging of the imaging unit 218 are transmitted to the inspection apparatus 108 via the inspection apparatus I/F 215. Note that the CISs forming the imaging unit 218 are an example of a reading sensor, and the reading sensor may be other types of reading sensor such as a CCD image sensor, and the reading method (imaging method) of the imaging unit 218 is not limited to a particular method.

### [About Control Configuration of Large-Capacity Stacker in Image Forming Apparatus]

The large-capacity stacker 107 of the image forming apparatus 101 includes the accessory I/F 220, a CPU 221, a RAM 222, a paper discharging unit 223, and a storage unit 248. These components are connected to one another via a system bus 224.

The CPU 221 performs computation and control of the units in the large-capacity stacker 107 via the system bus 224. Moreover, the CPU 221 executes a program stored in the storage unit 248 by loading the program onto the RAM 222. The RAM 222 is a general volatile memory that can be directly accessed by the CPU 221, and is used as a work area of the CPU 221 or as other temporal data storage areas. The storage unit 248 also functions as the temporal storage areas and the work memory.

The paper discharging unit 223 performs discharge operations to the main tray 324 (see FIG. 3) and the top tray 320 (see FIG. 3), and monitors and controls stacked statuses of the main tray 324 and the top tray 320.

### [About Control Configuration of Inspection Apparatus]

The inspection apparatus 108 includes a CPU 226, a RAM 227, a storage unit 228, a PDL analysis unit 229, the inspection unit I/F 231, an NW I/F 232, a display unit 245, and an operation unit 249. These components are connected to one another via a system bus 230.

The CPU 226 performs computation and control of the units in the inspection apparatus 108 via the system bus 230. Moreover, the CPU 226 executes a program stored in the storage unit 228 by loading the program onto the RAM 227. The RAM 227 is a general volatile memory that can be directly accessed by the CPU 226, and is used as a work area of the CPU 226 or as other temporal data storage areas. The storage unit 228 also functions as the temporal storage areas and the work memory in operations of the inspection apparatus 108.

The PDL analysis unit 229 receives PDL data (for example, PDF, PostScript, PCL, or the like) that is the print data transmitted from the client computer 110 or the information processing apparatus 109, reads the received PDL data, and executes analysis processing. Note that the PDL analysis unit 229 may be implemented by hardware or implemented by causing the CPU 226 of the inspection apparatus 108 to load a program code stored in the storage unit 228 onto the RAM 227 and execute the program code.

The display unit 245 is, for example, a liquid crystal display, and displays a state of the inspection apparatus 108 and the like for the user. The operation unit 249 is formed of, for example, a keyboard, a mouse, or a joystick, and inputs various instructions into the CPU 226 in response to operations by the user. The display unit 245 and the operation unit 249 may be configured to be integral such as a touch panel. The CPU 226 operates also as a display control unit configured to control the display unit 245 and as an operation control unit configured to control the operation unit 249. The display unit 245 and the operation unit 249 do not have to be included in the inspection apparatus 108, and may be connected to the inspection apparatus 108 as external apparatuses.

### [About Control Configuration of Image Processing Apparatus]

The information processing apparatus 109 includes a CPU 234, a RAM 235, a storage unit 236, an NW I/F 237 and the video I/F 233. These components are connected to one another via the system bus 239.

The CPU 234 performs computation and control of the units in the information processing apparatus 109 via the system bus 239. Moreover, the CPU 234 executes a program stored in the storage unit 236 by loading the program onto the RAM 235. The RAM 235 is a general volatile memory that can be directly accessed by the CPU 234, and is used as a work area of the CPU 234 or as other temporal data storage areas. The storage unit 236 also functions as the temporal storage areas and the work memory in operations of the information processing apparatus 109. The NW I/F 237 is connected to the NW I/F 232 of the inspection apparatus 108 and an NW I/F 240 of the client computer 110 via a network. The information processing apparatus 109 communicates with the inspection apparatus 108 via the NW I/F 237 and the NW I/F 232. Moreover, the information processing apparatus 109 communicates with the client computer 110 via the NW I/F 237 and the NW I/F 240.

### [About Control Configuration of Client Computer]

The client computer 110 includes the NW I/F 240, a RAM 242, a CPU 243, and a storage unit 244. These components are connected to one another via a system bus 246. The CPU 243 performs computation and control of the units in the client computer 110 via the system bus 246. Moreover, the CPU 243 executes a program stored in the storage unit 244 by loading the program onto the RAM 242. The RAM 242 is a general volatile memory that can be directly accessed by the CPU 243, and is used as a work area of the CPU 243 or as other temporal data storage areas. The storage unit 244 also functions as the temporal storage areas and the work memory in operations of the client computer 110.

### [About Conveyance of Paper Sheet in Print Operation]

FIG. 3 is a mechanical cross-sectional diagram expressing overview configurations of the print unit 111, the inspection unit 106, and the large-capacity stacker 107 forming the image forming apparatus 101. Conveyance of the paper sheets in the print operation and a print processing operation by development stations and fixing units included in the printer engine 210 are described by using FIG. 3.

First, the conveyance of the paper sheets and the print processing operation in the print unit 111 are described. The paper feed decks 103 and 104 are configured to be capable of storing various types of paper sheets, and are configured such that one top paper sheet among the stored paper sheets can be separated and conveyed to a paper sheet conveyance path 305.

Development stations 301 to 304 form toner images by using color toners of Y, M, C, and K, respectively, to form a color image. The toner images formed herein are subjected to primary transfer to an intermediate transfer belt 306. The intermediate transfer belt 306 rotates clockwise in FIG. 3, and the toner images are transferred to the paper sheet conveyed from the paper sheet conveyance path 305 at a secondary transfer position 307.

A first fixing unit 308 includes a pressure roller and a heating roller. The paper sheet is passed between the rollers, and the toners are thereby melted and fixed under pressure. The toner images are thereby fixed to the paper sheet. The paper sheet having passed the first fixing unit 308 is conveyed to a paper sheet conveyance path 312 through a paper sheet conveyance path 309, and is conveyed to the inspection unit 106.

There is a case where further melting and fixing under pressure are required for fixation depending on the type of the paper sheet. In such a case, the paper sheet is conveyed to a second fixing unit 310 by using an upper paper sheet conveyance path 311 after having passed the first fixing unit 308. In this case, the paper sheet is subjected to additional melting and fixing under pressure in the second fixing unit 310, and then conveyed to a paper sheet conveyance path 312. In the case where a print mode is duplex, the paper sheet is conveyed to a paper sheet reversing path 313. Next, the paper sheet is reversed in the paper sheet reversing path 313, then conveyed to a duplex conveyance path 314, and image transfer to the back side of the paper sheet is performed at the secondary transfer position 307.

In the inspection unit 106, a CIS 315 and a CIS 316 that are the imaging unit 218 in the present embodiment are arranged to face each other. The CIS 315 is an imaging unit (reading unit) for reading an upper surface (front surface) of each print product that is the paper sheet on which images are printed by the print processing, and the CIS 316 is an imaging unit (reading unit) for reading a lower surface (back surface) of the print product. In the inspection unit 106, the CISs 315 and 316 read the print product by imaging the print product at a timing at which the print product conveyed through a paper sheet conveyance path 317 reaches an imaging range of the imaging unit 218. Read images of the print product obtained by causing the CISs 315 and 316 to image the print product are transmitted to the inspection apparatus 108 via the inspection apparatus I/F 215 and the inspection unit I/F 231.

The CPU 226 of the inspection apparatus 108 determines whether there is a defect in the print product based on the received read images. The inspection unit 106 is notified of a result of the inspection by the inspection apparatus 108 via the inspection unit I/F 231 and the inspection apparatus I/F 215. The CPU 216 of the inspection unit 106 notifies the large-capacity stacker 107 of the received determination result via the accessory I/F 214 and the accessory I/F 220.

The paper sheet having passed the inspection unit 106 is conveyed to the large-capacity stacker 107 through a paper sheet conveyance path 319. The large-capacity stacker 107 includes the main tray 324 that is a tray on which the print products are stacked. The print products are stacked on the main tray 324 by being conveyed from the paper sheet conveyance path 319 via a paper sheet conveyance path 322.

Moreover, the large-capacity stacker 107 includes the top tray 320 as the paper discharge tray. The top tray 320 is a paper discharge tray used to discharge the print product determined to have a defect by the inspection apparatus 108.

The CPU 221 of the large-capacity stacker 107 controls the conveyance of the print products such that the print product in which a defect is detected by the inspection apparatus 108 is discharged to the top tray 320. In the case where the print product is discharged to the top tray 320, the print product is conveyed from the paper sheet conveyance path 319 to the top tray 320 via a paper sheet conveyance path 321.

A reversing unit 323 functions in reversal of the print products. In the case where the print products are to be stacked on the main tray 324 such that the orientation of the print products at a point where the print products are carried out is the same as the orientation of the print products carried in, the reversing unit 323 can reverse the print products. In the case where the print products are conveyed to the top tray 320, the print products are directly discharged without being flipped over in the stacking. Accordingly, the print products are not conveyed to the reversing unit 323.

### [Functional Arrangement of Inspection Apparatus]

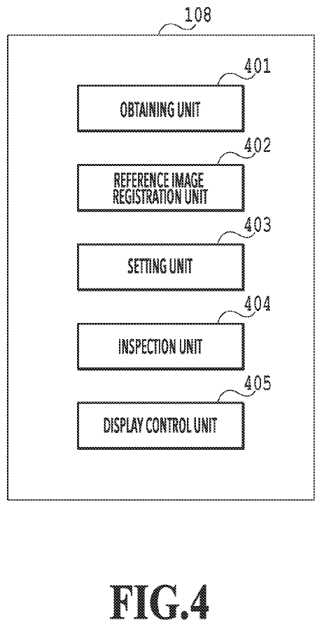

FIG. 4 is a block diagram illustrating a functional arrangement of the inspection apparatus 108. The inspection apparatus 108 includes an obtaining unit 401, a reference image registration unit 402, a setting unit 403, an inspection unit 404, and a display control unit 405.

The obtaining unit 401 obtains the read images obtained by causing the inspection unit 106 to read the print product obtained by the printing performed in the print unit 111 of the image forming apparatus 101. The reference image registration unit 402 performs processing of registering a reference image. The setting unit 403 performs setting of inspection regions that are regions to be inspected by the inspection unit 404, a type of inspection in the case where the inspection is performed by the inspection unit 404, and the like. The inspection unit 404 performs processing of inspecting whether the print product has a defect or not by using the read images of the print product. The display control unit 405 performs control of displaying a screen on the display unit 245 or the like.

The CPU 226 of the inspection apparatus 108 loads a program code stored in the storage unit 228 onto the RAM 227, and executes the program code to implement functions of the respective units in FIG. 4. Alternatively, some or all of the functions of the respective units in FIG. 4 may be implemented by hardware such as an ASIC or an electronic circuit.

### [About Overall Flow]

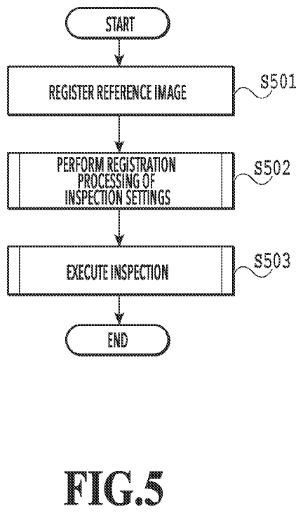

FIG. 5 is a flowchart for explaining an overall flow from registration processing of the reference image before start of the inspection to execution of the inspection in the inspection apparatus 108.

The CPU 226 of the inspection apparatus 108 loads the program code stored in the storage unit 228 onto the RAM 227, and executes the program code to perform processes to be executed by the inspection apparatus 108 in the series of processes illustrated in the flowchart.

Moreover, the CPUs of the image forming apparatus 101, the information processing apparatus 109, and the client computer 110 load program codes stored in the storage devices of the respective apparatuses onto the RAMs of the respective apparatuses, and execute the program codes to perform processes to be executed by the image forming apparatus 101, the information processing apparatus 109, and the client computer 110.

Furthermore, some or all of functions of steps in the flowchart may be implemented by hardware such as an ASIC or an electronic circuit. Note that the symbol “S” in description of each process means step in the flowchart, and the same applies to the following flowcharts.

In S501, the CPU 226 of the inspection apparatus 108 performs the processing of registering the reference image to be a reference of inspection. The reference image is an image obtained as a result of reading a print product with no defect in which the same image as that of a print product being an inspection target is printed.

For example, the user operates the client computer 110 to cause the client computer 110 to generate a print job for generating the reference image and transmit the generated print job to the image forming apparatus 101. In the print unit 111 of the image forming apparatus 101, the print product is generated based on the print job, and the imaging unit 218 of the inspection unit 106 reads the generated print product. Then, the read image obtained by causing the imaging unit 218 to read the print product is transmitted to the inspection apparatus 108.

The inspection apparatus 108 registers the received read image as the reference image. The configuration may be such that, in this case, multiple print products are read, and multiple read images obtained as a result of this reading are synthesized to generate the reference image. Alternatively, the reference image may be generated from RIP data or the like used in printing of the print product being the inspection target.

In S502, the CPU 226 of the inspection apparatus 108 performs processing of registering inspection regions being inspection targets and inspection settings expressing contents of inspection for each of the inspection regions, based on selection of the user. In S502, parameters of various types of inspection and setting values relating to the inspection regions and the like are registered. Details are described later.

In S503, the inspection apparatus 108 inspects the print product based on the inspection settings registered in S502.

A flow of the inspection is as follows. First, the user operates the client computer 110, and causes the client computer 110 to generate the print job for printing the print product being the inspection target and transmit the generated print job to the image forming apparatus 101. The print unit 111 of the image forming apparatus 101 generates the print product based on the print job. The inspection unit 106 detects conveyance of the print product, and causes the imaging unit 218 (CISs 315 and 316) to read the conveyed print product, and the read image obtained as a result of the reading is transmitted to the inspection apparatus 108. The inspection apparatus 108 saves the received read image for which the start of inspection is instructed by the user in the RAM 227 of the inspection apparatus 108. Then, in S503, the inspection apparatus 108 executes the inspection on the saved read image based on the inspection settings, and outputs an inspection result. The inspection is executed based on the setting values and the like registered in S502 and specified by the user. Details of the inspection are described later.

### [About Type of Inspection on Code Image]

The print product of the present embodiment includes code images (code symbols) such as a bar code and a two-dimensional code, and the inspection apparatus 108 inspects the code images included in the print product. Types of inspection on the code images include, for example, a decoding inspection and a grade inspection. Moreover, as an inspection executed together with the decoding inspection or the grade inspection, there is a comparison inspection.

In the present embodiment, description is given assuming that at least the decoding inspection or the grade inspection is executed on each of the inspection regions that are regions to be targets of inspection in the read image of the print product. The grade inspection takes time in some cases, and if the grade inspection is performed on all inspection regions, the inspection time increases. Accordingly, the present embodiment is configured such that whether to perform the grade inspection or the decoding inspection can be set for each inspection region. Accordingly, an increase in the inspection time can be suppressed. Note that the types of inspection on the code images are not limited to particular types. In the inspection, “inspection passed” is outputted as an inspection result in the case where there is no abnormality (defect) and the inspection region is normal, and “inspection failed” is outputted as the inspection result in the case where there is an abnormality (defect).

The decoding inspection is inspection in which the code image being the inspection target is decoded, and “inspection passed” is outputted in the case where the decoding is successful while “inspection failed” is outputted in the case where the decoding fails. Inspection on whether or not the information obtained as a result of the decoding is correct is not performed. The inspection on whether or not the information obtained as a result of the decoding is correct is performed in the comparison inspection to be described later. The decoding inspection is selected, for example, in the case where the user desires inspection of whether or not the code image has become an illegible image due to crushing of a white line portion in the two-dimensional code. In the case where there is no need to perform comparison with the decoded result as in printing of a fixed pattern, the decoding inspection including no comparison inspection is performed.

In the grade inspection, a grade that is an evaluation value expressing a quality level of the code image is measured. The grade is measured according to standards of JIS-X-0510, JIS-X-0520, JIS-X-0526, and the like. The grade is assumed to be measured in, for example, six levels of A to F which are in the descending order. Moreover, this inspection is an inspection in which “inspection passed” is outputted in the case where the measured grade is equal to or higher than a threshold and “inspection failed” is outputted in the case where the measured grade is lower than the threshold. The threshold is a minimum allowable value of the grade, and is referred to as grade border.

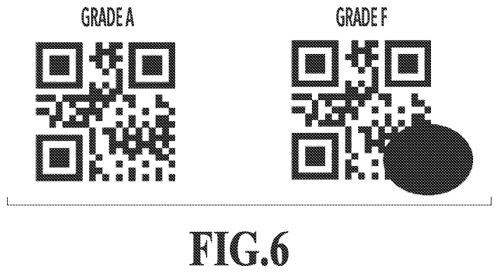

FIG. 6 is a diagram illustrating an example of the code image whose grade is measured to be A in the grade inspection and an example of the code image whose grade is measured to be F. As illustrated in FIG. 6, in the case where there is a smear in part of the code image, the grade is measured to be low.

In the grade inspection, the measurement of the grade is performed for multiple inspection items. For example, the grade with the smallest value among the grades of the respective inspection items is compared with the grade border. The multiple inspection items include, for example, (1) decoding, (2) contrast, (3) boldness, and (4) correction.

The decoding is an inspection item in which the grade A is measured in the case where the decoding of the code image is successful and the grade F is measured in the case where the decoding fails. The contrast is an inspection item in which the higher (stronger) the contrast of black and white is, the higher the measured grade is. The boldness is an inspection item in which a grade relating to the boldness of a cell is measured. In the case of the two-dimensional code, the grade is measured such that a grade is low, for example, in the case where the shape of the cell or the entire code is deformed in reading in an oblique direction. The correction is an inspection item as follows. In the case of the one-dimensional code, there is a parameter referred to as decodability, and the grade is measured by using this parameter.

Since the decoding in the grade inspection is inspection similar to the decoding inspection described above, it can be said that the grade inspection includes the decoding inspection. Moreover, since no inspection other than the inspection item of decoding in the grade inspection is performed in the decoding inspection, the grade inspection is an inspection with more inspection items than the decoding inspection.

The comparison inspection is an inspection of comparing a character string obtained by decoding the code image in each inspection region and a correct character string to determine whether the character strings match each other. In the present embodiment, the comparison inspection is assumed to be performed as part of the decoding inspection or part of the grade inspection.

A reference CSV file is an example of a file including the correct character string, and is prepared in advance by the user in the case where the comparison inspection is to be performed. Table 1 is a table for explaining a structure of data held in the reference CSV file.

TABLE 1

| | Region ID 1 | Region ID 2 | Region ID 3 | Region ID 4 |
|---|---|---|---|---|
| First sheet | AAAA | 1111 | aaaa | 4444 |
| Second sheet | BBBB | 2222 | bbbb | 5555 |
| Third sheet | CCCC | 3333 | cccc | 6666 |

For example, each column of the reference CSV file corresponds to a region ID that is a value specifying the inspection region. As illustrated in Table 1, assume that the correct character strings for the first sheet are held in the first row of the reference CSV file, and character strings of “AAAA”, “1111”, “aaaa”, and “4444” are held in the respective columns of the first row. In this case, in the comparison inspection for the first sheet, the correct character string for the inspection region with the inspection ID of “1” is “AAAA”, and inspection of whether the character string obtained by decoding the inspection region with the region ID of “1” in the first sheet matches the correct character string “AAAA” is performed. As described above, in the execution of the comparison inspection, link with the reference CSV file is performed based on the region ID to perform the comparison inspection.

### [About Inspection Setting Screen]

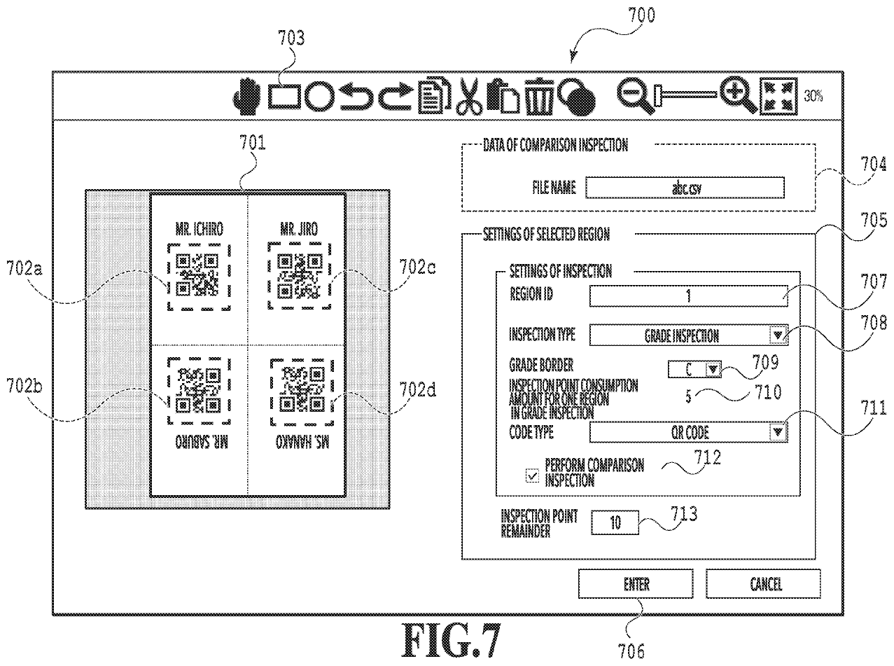

FIG. 7 is a diagram illustrating an example of an inspection setting screen 700 that is an UI screen in which the user specifies contents of the inspection. In S502, the inspection settings indicating the inspection contents selected by the user in the inspection setting screen 700 are registered. In the case where the user selects the reference image from among the reference images registered in S501, the CPU 226 of the inspection apparatus 108 performs display control of displaying the inspection setting screen 700 on the display unit 245 of the inspection apparatus 108.

A preview display region 701 is a region in which the selected reference image is displayed as a preview. In the case where a print product with multiple pages is the inspection target, the reference images for multiple pages are selected. If the user performs an operation of switching the reference image displayed as a preview in this case, the CPU 226 receives this operation and switches the reference image displayed in the preview display region 701. The reference image of the corresponding page can be thereby displayed as a preview.

Rectangular dotted-line frames arranged to be superimposed on the reference image displayed in the preview display region 701 as a preview express inspection regions 702a to 702d set by the user. The inspection regions 702a to 702d are regions to be the inspection targets in the print product. FIG. 7 illustrates an example in which the inspection regions 702a to 702d are set, respectively, in four regions including two-dimensional codes on the reference image.

The inspection regions 702a to 702d are arranged on the reference image displayed as a preview in the case where the user presses an inspection region arrangement button 703. Specifically, in the case where the user presses the inspection region arrangement button 703 by a mouse click operation, a pull-down menu is displayed. In the case where the user selects a type of inspection region from the pull-down menu, a rectangular dotted-line frame for setting the inspection region corresponding to the type is displayed. In the present embodiment, description is given assuming that the code image is selected as the type of inspection region. The user can change the size and position of the rectangular dotted-line frame by a mouse drag operation. The user arranges the rectangular dotted-line frame on a region that the user desires to set as the inspection region on the preview display region 701 by a mouse drag, and the setting of the inspection region is thereby received.

A file selection region 704 is a region for selecting data to be used in the comparison inspection by a file selection method. As described above, the data of the comparison inspection is the reference CSV file holding the correct character string used in the case where the comparison inspection is performed.

An inspection content setting region 705 is a region in which the user selects the contents of inspection performed in the case where the currently-selected inspection region is inspected. The user clicks one of the inspection regions 702a to 702d arranged on the preview display region 701 to select the inspection region to be a selection target of the inspection contents. The user can select the inspection method and the like for each of the inspection regions. The inspection content setting region 705 includes an ID display region 707, a pull-down 708, a pull-down 709, a consumed inspection point display region 710, a pull-down 711, and a check box 712.

The ID display region 707 is a region in which the ID (referred to as region ID) of the currently-selected inspection region is displayed. In FIG. 7, the inspection region 702a with the region ID of “1” among the four inspection regions 702a to 702d on the preview display region 701 is selected.

The pull-down 708 is a pull-down for selecting the type of inspection to be executed on the currently-selected inspection region. The user can select the grade inspection or the decoding inspection as the type of inspection from the pull-down 708. In the inspection, the type of inspection selected in the pull-down 708 is performed on the currently-selected inspection region. For example, in FIG. 7, the grade inspection is selected from the pull-down 708 for the inspection region 702a with the region ID of “1”. Accordingly, in the case where an enter button 706 is pressed in the inspection setting screen 700 of FIG. 7, the grade inspection is performed for the inspection region with the region ID of “1”.

Next, the pull-down 709 and the consumed inspection point display region 710 are regions in which input or display is enabled in the case where the grade inspection is selected in the pull-down 708.

The pull-down 709 is a pull-down for selecting the grade border that is the minimum allowable value of the grade in the grade inspection. The grade border is selected for each inspection region. For example, in FIG. 7, “C” is selected as the grade border of the inspection region 702a with the inspection ID of “1”. Accordingly, in the case where the inspection region 702a with the inspection ID of “1” is inspected, “inspection passed” is outputted if the grade inspection is performed and the grade calculated in the grade inspection is C or higher. Meanwhile, “inspection failed” is outputted if the grade calculated in the grade inspection is lower than C.

The consumed inspection point display region 710 is a region for displaying a consumption amount of inspection points in the case where the currently-selected inspection region is inspected. The consumption amount of the inspection points is described later.

The pull-down 711 is a pull-down for selecting the type (code type) of code image included in the currently-selected inspection region. For example, Code 39, Code 93, ITF, NW-7, JAN, QR code (registered trademark) that is a two-dimensional code, Data Matrix, and the like are used as the code type (standard of code).

The check box 712 is used to select whether to execute the comparison inspection or not. In the case where the check box 712 is checked, the comparison inspection is executed by using the region ID and the reference CSV file in the inspection of the currently-selected inspection region.

An inspection point remainder display region 713 is a region holding a value obtained by subtracting a total of consumption amounts of the inspection points for the respective selected inspection regions from inspection points given in advance. Details are described later.

In the case where the user presses the enter button 706, the CPU 226 terminates the display of the inspection setting screen 700. Then, the CPU 226 saves the inspection regions selected in the inspection setting screen 700 and the inspection settings indicating the contents of inspection for each inspection region in the RAM 227.

### [About Inspection Points]

The consumption amount of the inspection points displayed in the consumed inspection point display region 710 of FIG. 7 is a value calculated depending on the time required to inspect the selected inspection regions. The consumption amount of the inspection points is calculated assuming that time required for the decoding inspection of one inspection region is 1. Specifically, it assumed that, in the case where the decoding inspection is selected from the pull-down 708, the consumption amount of the inspection points is determined to be 1.

Since time required for the grade inspection is several times longer than the time required for the decoding inspection in some cases, the consumption amount of the inspection points sometimes takes a value larger than 1. For example, in the case where the code type is Code 39, the time required for the grade inspection is about the same as the time required for the decoding inspection. Accordingly, the consumption amount of the inspection points is calculated as 1 as in the decoding inspection. Meanwhile, in the case of the two-dimensional code, the grade inspection takes time, and the consumption amount of the inspection points is thus calculated to be 5. This means that, in the case where the grade inspection is performed on the two-dimensional code, time five times longer the time taken for execution of the decoding inspection is required.

As described above, in the case of the grade inspection, since the time required for the inspection varies depending on the type of the code image being the inspection target, the consumption amount of the inspection points varies. Accordingly, in the case where the code type of the currently-selected inspection region is selected in the pull-down 711, the consumption amount of the inspection points is calculated and displayed on the consumed inspection point display region 710. The consumption amount of the inspection points in the grade inspection is determined by using, for example, a table in which the code types are added.

As described above, in the present embodiment, the calculated consumption amount of the inspection points is assumed to be displayed in the consumed inspection point display region 710 in the case where the grade inspection is selected. The time required for the grade inspection is sometimes several times longer than the time required for the decoding inspection. Accordingly, the consumption amount of the inspection points is used also as an index indicating that time required for execution of the grade inspection is how many times longer than the time required for the decoding inspection. The consumption amount of the inspection points does not have to be displayed in the consumed inspection point display region 710 in the case where the decoding inspection is selected.

Next, a value displayed in the inspection point remainder display region 713 is described. In the present embodiment, control is performed such that the discharge destination of the print product is changed in the large-capacity stacker 107 depending on the inspection result. Accordingly, the inspection apparatus 108 needs to complete the inspection within the inspection time from the reading of the print product of the inspection target page by the imaging unit 218 of the inspection unit 106 to the discharge of the print product. The inspection points corresponding to the inspection time that can be spent for inspection of this one page are assumed to be calculated in advance. For example, assume that 30 is given as the inspection points. The given inspection points are calculated assuming that the time required for execution of the decoding inspection for one inspection region is 1, as in the consumption amount of the inspection points.

As described above, in the case where the inspection regions are selected in the inspection setting screen 700 of FIG. 7 and the contents of inspection for the selected inspection regions are selected, the consumption amount of the inspection points expressing the time required for the inspection is calculated for each inspection region. A value obtained by subtracting the consumption amount of the inspection points from the given inspection points is displayed in the inspection point remainder display region 713.

The four inspection regions 702a to 702d are set in the preview display region 701 of the inspection setting screen 700 in FIG. 7. In the case where the grade inspection is selected as the type of inspection and the two-dimensional code is selected as the code type for each of the four inspection regions 702a to 702d, the consumption amount of the inspection points in one inspection region is calculated as 5. Accordingly, the total of the consumption amounts of the inspection points in inspection of the print product including the four inspection regions 702a to 702d displayed in the preview display region 701 is 5×4=20. In the case where 30 is given as the inspection points corresponding to the inspection time that can be spent for inspection of one page, the inspection point remainder is calculated as 30−20=10. Accordingly, 10 is displayed in the inspection point remainder display region 713 of FIG. 7.

In the case where the number of points displayed in the inspection point remainder display region 713 is 0 or more, this means that the inspection can be completed within the inspection time that can be spent for inspection of one page. Accordingly, the CPU 226 is configured to receive the contents of inspection displayed in the inspection setting screen 700 in the case where the number of points displayed in the inspection point remainder display region 713 is 0 or more.

### [Flowchart of Registration Processing of Inspection Setting]

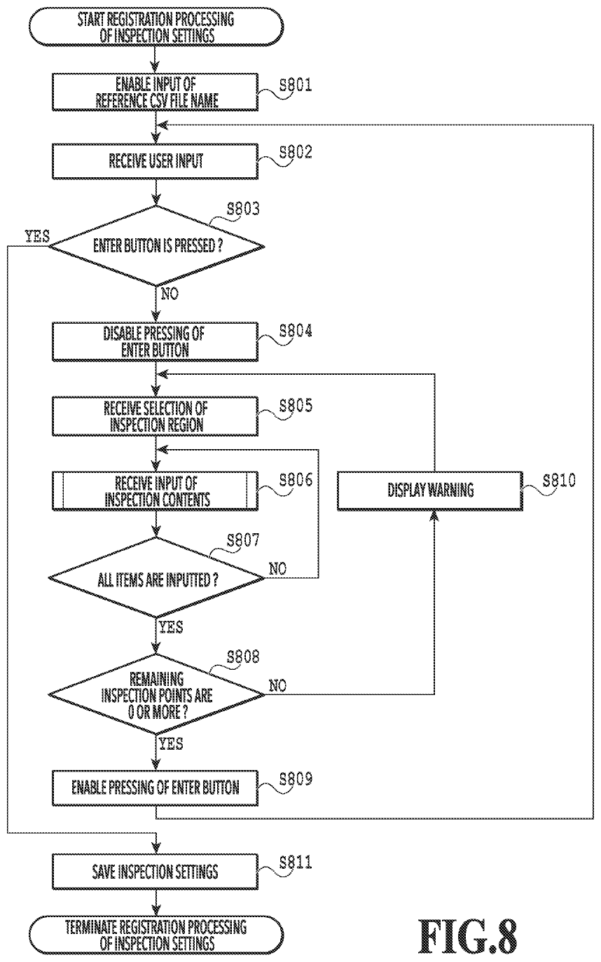

FIG. 8 is a flowchart for explaining details of registration processing of the inspection settings in S502.

In S801, the CPU 226 displays the inspection setting screen 700 on the display unit 245. Then, the CPU 226 enables input into the file selection region 704 of the inspection setting screen 700. For example, the file selection region 704 is changed from a state in which the input of the user is disabled by graying-out the file selection region 704 to a state in which the user can perform the input. In the case where the user selects the comparison inspection, the user inputs the file name of the reference CSV file to be used for the comparison inspection, into the file selection region 704.

In S802, the CPU 226 receives input for the inspection setting screen 700 made by the user. The flowchart is described below assuming that the user presses the enter button 706 or performs input relating to the inspection region. The input relating to the inspection region is input of a new setting of the inspection region by the pressing of the inspection region arrangement button 703 or input of selection of the inspection region already set in the preview display region 701.

In S803, the CPU 226 determines whether the user input received in S802 is the pressing of the enter button 706 or the input relating to the inspection region. In the case where the CPU 226 determines that the input received in S802 is the input relating to the inspection region (NO in S803), the CPU 226 transitions the processing to S804.

In S804, the CPU 226 temporarily disables the enter button 706 to prevent reception of the pressing of the enter button 706 by the user. This is performed to prevent the inspection contents from being saved during editing of the inspection contents.

In S805, the CPU 226 selects a processing target inspection region. In the case where the pressing of the inspection region arrangement button 703 is received in S802, the CPU 226 newly arranges and sets the inspection region at the position specified by the user operation in the preview display region 701, in size specified by the user operation. Then, the CPU 226 selects the newly-set inspection region as the processing target. In the case where the inspection region already set in the preview display region 701 is selected, the CPU 226 selects this inspection region as the processing target. In the case where the processing target inspection region is already selected as in transition from S810 to S805, S805 may be skipped. In S805, changing of the processing target inspection region, cancel of the inspection region, or the like may be received.

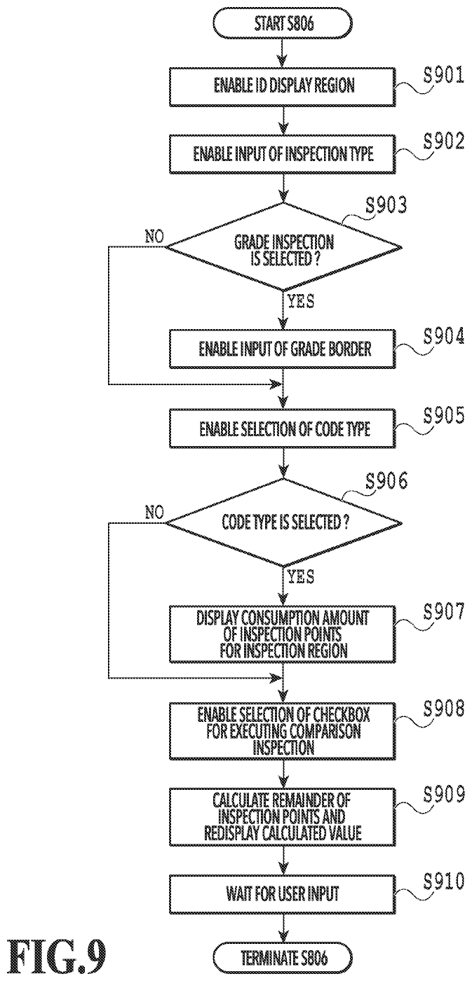

In S806, the CPU 226 receives input of the inspection contents for the case where the processing target inspection region is inspected. Specifically, the CPU 226 receives input in the inspection content setting region 705 corresponding to the processing target inspection region. Details of the processing of S806 are described by using FIG. 9.

In S807, the CPU 226 determines whether all items in the inspection content setting region 705 are inputted. In the case where the CPU 226 determines that not all of the items in the inspection content setting region 705 are inputted (NO in S807), the CPU 226 returns to S806, and receives input of the items in the inspection content setting region 705 again.

In the case where the CPU 226 determines that all items in the inspection content setting region 705 are inputted (YES in S807), the CPU 226 proceeds to S808. In S808, the CPU 226 determines whether the remainder of the given inspection points displayed in the inspection point remainder display region 713 of the inspection setting screen 700 is 0 or more.

In the case where the CPU 226 determines that the remainder of the given inspection points is less than 0 (NO in S808), the CPU 226 causes the processing to proceed to S810. As described above, the remainder of the given inspection points being less than 0 means that the inspection cannot be completed within the inspection time usable for the inspection of the print product for the inspection contents selected in the inspection setting screen 700. Accordingly, the inspection contents inputted in S806 cannot be registered as the inspection settings. Thus, in S810, the CPU 226 displays a warning on the display unit 245 as a predetermined notification that indicates that the remainder of the given inspection points is less than 0 and that prompts rethinking of the inspection contents. Then, the CPU 226 causes the processing to return to S805, and performs the processing of receiving the input of the inspection contents again such that the remainder of the given inspection points becomes 0 or more.

In the case where the CPU 226 determines that the remainder of the inspection points is 0 or more (YES in S808), the CPU 226 causes the processing to proceed to S809. In S809, the CPU 226 enables the enter button 706 that has been disabled. Then, the CPU 226 causes the processing to transition to S802.

In the case where the CPU 226 determines that the input received in S802 is the pressing of the enter button 706 (YES in S803), the CPU 226 causes the processing to proceed to S811. In S811, the CPU 226 saves the inspection regions inputted up to this moment and the inspection settings including the contents of inspection for each inspection region in the RAM 227, and terminates the present flowchart.

FIG. 9 is a flowchart for explaining details of processing of receiving the input in the inspection content setting region 705 for the processing target inspection region in S806.

In S901, the CPU 226 allows input of the region ID in the ID display region 707.

In S902, the CPU 226 enables the pull-down 708 in the inspection content setting region 705 to allow the user to select the type of inspection from the pull-down 708.

In S903, the CPU 226 determines whether the type of inspection selected from the pull-down 708 is the grade inspection or not. In the case where the CPU 226 determines that the selected type of inspection is the grade inspection (YES in S903), the CPU 226 causes the processing to proceed to S904.

In S904, the CPU 226 enables the pull-down 709 in the inspection content setting region 705 to allow the user to select the grade to be set as the grade border from the pull-down 709. Then, the CPU 226 causes the processing to proceed to S905.

Meanwhile, in the case where the CPU 226 determines that the grade inspection is not selected from the pull-down 708 (NO in S903), the CPU 226 skips S904, and causes the processing to proceed to S905.

In S905, the CPU 226 enables the pull-down 711 in the inspection content setting region 705 to allow the user to select the code type of the code image included in the processing target inspection region from the pull-down 711.

In S906, the CPU 226 determines whether the code type of the code image included in the processing target inspection region is selected. In the case where the CPU 226 determines that the code type of the code image is selected (YES in S906), the CPU 226 causes the processing to proceed to S907.

In S907, the CPU 226 calculates the consumption amount of the inspection points in the case where the processing target inspection region is inspected. Then, the CPU 226 displays the calculated consumption amount of the inspection points in the consumed inspection point display region 710. Since the consumption amount of the inspection points varies depending on the code type in the case of the grade inspection, the consumption amount of the inspection points displayed in the consumed inspection point display region 710 is displayed after the selection of the code type of the inspection region.

In the case where the CPU 226 determines that the code type is not selected (NO in S906), the CPU 226 skips S907, and causes the processing to transition to S908.

In S908, the CPU 226 enables input to the check box 712 in the inspection content setting region 705 to allow the user to select whether to execute the comparison inspection or not.

In S909, the CPU 226 calculates the remainder of the given inspection points. Then, the CPU 226 displays the calculated value in the inspection point remainder display region 713. In the case where the grade inspection is selected in S903 and no code type is selected in S906, the consumption amount of the inspection points cannot be calculated. Accordingly, display control of not displaying a numeric value such as “code type is not selected” is performed in the inspection point remainder display region 713.

In S910, the CPU 226 waits for input of settings by the user. Then, the present flowchart is terminated.

For example, in the case where the flowchart of FIG. 9 is terminated with no code type selected in S906, determination of NO is made in S807 of FIG. 8, and the processing returns to S806. Then, the processing of the flowchart of FIG. 9 is performed again.

### [Flowchart of Inspection Processing]

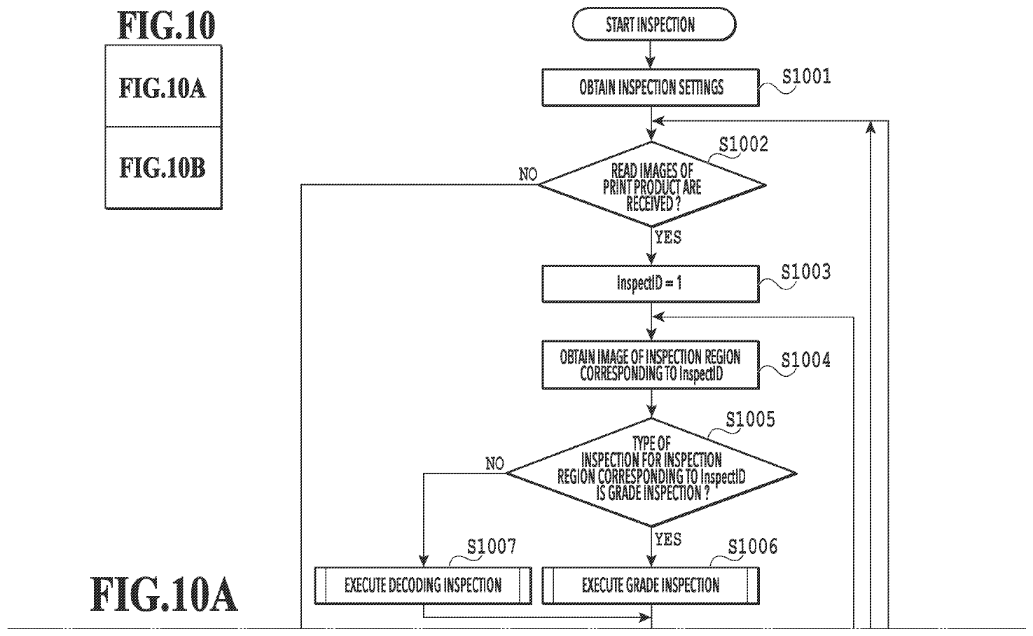

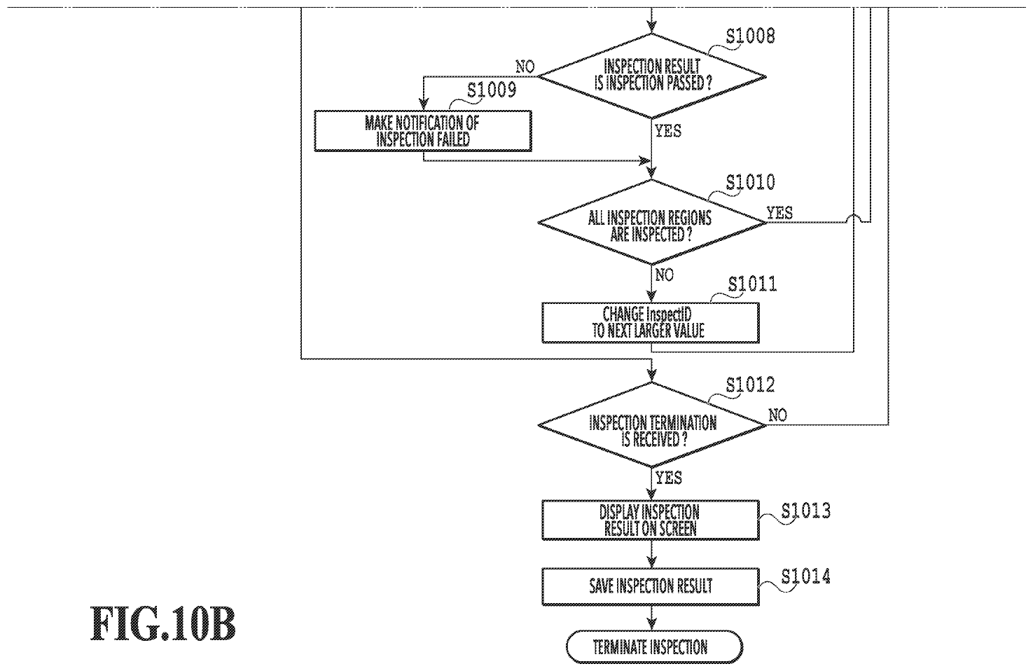

FIGS. 10A and 10B are flowcharts for explaining details of the inspection processing in S503.

In S1001, the CPU 226 obtains the inspection settings saved in S502 and corresponding to the print product being the inspection target.

In S1002, the CPU 226 determines whether the read images obtained by causing the CISs 315 and 316 of the image forming apparatus 101 to read the print product being the inspection target are received.

In the case where the CPU 226 determines that the read images of the print product being the inspection target are received (YES in S1002), the CPU 226 causes the processing to proceed to S1003.

In S1003, the CPU 226 sets a variable InspectID to “1”.

In S1004, the CPU 226 selects the inspection region associated with the region ID matching the current value of InspectID, as the inspection target. Then, the CPU 226 obtains an image of the inspection region being the inspection target from the received read images of the print product, based on the position and size of the inspection region being the inspection target among the inspection regions that are included in the inspection settings.

In S1005, the CPU 226 determines whether the type of inspection for the inspection region being the inspection target is the grade inspection or not, based on the inspection settings obtained in S1001.

In the case where the type of inspection for the inspection region being the inspection target is determined to be the grade inspection (YES in S1005), the CPU 226 causes the processing to proceed to S1006. In S1006, the CPU 226 executes the grade inspection on the image, obtained in S1004, of the inspection region being the inspection target. Details of the processing of S1006 are described later.

In the case where the type of inspection for the inspection region being the inspection target is determined to be the decoding inspection (NO in S1005), the CPU 226 causes the processing to proceed to S1007. In S1007, the CPU 226 executes the decoding inspection on the image, obtained in S1004, of the inspection region being the inspection target. Details of the processing of S1007 are described later.

In S1008, the CPU 226 determines whether the inspection result for the inspection region being the inspection target is “inspection passed” or “inspection failed”. In the case where the CPU 226 determines that the inspection result is “inspection failed” (NO in S1008), the CPU 226 causes the processing to proceed to S1009.

In S1009, the CPU 226 displays that the inspection result for the inspection region being the inspection target is inspection failed, on the display unit 245. Moreover, the CPU 226 notifies the CPU 221 of the large-capacity stacker 107 in the image forming apparatus 101 that the inspection result is inspection failed. Then, the CPU 226 causes the processing to proceed to S1010. In the case where the CPU 221 of the large-capacity stacker 107 receives that the inspection result is inspection failed from the inspection apparatus 108, the CPU 221 controls the conveyance such that the print product including the inspection target for which the inspection result is inspection failed is discharged to the top tray 320.

Meanwhile, in the case where the CPU 226 determines that the inspection result is “inspection passed” (YES in S1008), the CPU 226 skips S1009, and causes the processing to proceed to S1010. In the case where the CPU 221 of the large-capacity stacker 107 does not receive that the inspection result is inspection failed from the inspection apparatus 108, the CPU 221 controls the conveyance such that the print product being the inspection target is discharged to the main tray 324.

In S1010, the CPU 226 determines whether the inspection is completed for all inspection regions set for the print product being the current inspection target. In the case where the CPU 226 determines that the inspection for all inspection regions in the print product is not completed (NO in S1010), the CPU 226 causes the processing to proceed to S1011. In S1011, the CPU 226 changes the value of InspectID to the next larger value. Then, the CPU 226 returns to S1004, selects an inspection region associated with a region ID matching the changed value of Inspect ID as the new inspection target, and proceeds to inspection of the inspection region being the new inspection target.

In the case where the CPU 226 determines that the inspection for all inspection regions in the print product is completed (YES in S1010), the CPU 226 returns to S1002, and waits for reception of the read images of the print product being the next inspection target.

In the case where the CPU 226 determines that no new read images are received (NO in S1002), the CPU 226 causes the processing to proceed to S1012.

In S1012, the CPU 226 determines whether an instruction of inspection termination is received from the user. In the case where the CPU 226 determines that the instruction of inspection termination is not received (NO in S1012), the CPU 226 returns to S1002, and waits for reception of the read images of the print product being the next inspection target.

In the case where the CPU 226 determines that inspection for all print products is completed and the instruction of inspection termination is received (YES in S1012), the CPU 226 causes the processing to proceed to S1013. In S1013, the CPU 226 displays the inspection result on the display unit 245.

In S1014, the CPU 226 saves the inspection result in the RAM 227, and terminates the present flowchart.

### [Flowchart of Grade Inspection]

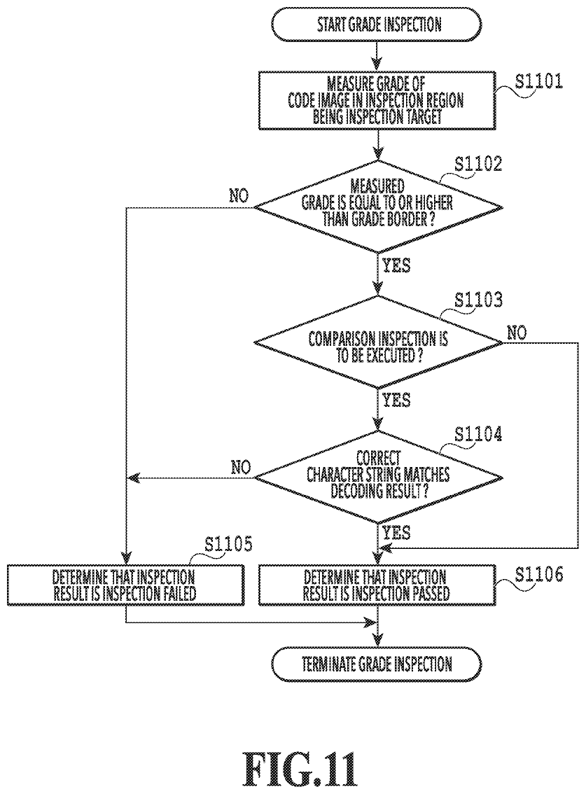

FIG. 11 is a flowchart for explaining details of the grade inspection executed in S1006 for the inspection region being the inspection target.

In S1101, the CPU 226 measures the grade of the code image included in the inspection region being the inspection target.

In S1102, the CPU 226 determines whether the grade obtained as a result of the measurement in S1101 is a grade equal to or higher than the grade border set to be associated with the inspection region being the inspection target. As described above, the grade border is an allowable minimum value (threshold) of the grade.

In the case where the CPU 226 determines that the measured grade is lower than the grade border (NO in S1102), the CPU 226 causes the processing to proceed to S1105, and determines that the inspection result for the inspection region being the inspection target is “inspection failed”. Then, the CPU 226 terminates the present flowchart.

In the case where the measured grade is equal to or higher than the grade border, the grade inspection is passed. However, in the case where the comparison inspection is selected to be executed by being included in the grade inspection, the CPU 226 determines that the inspection result for the inspection region being the inspection target is “inspection passed” if the comparison inspection is also passed. In the case where the CPU 226 determines that the measured grade is equal to or higher than the grade border (YES in S1102), the CPU 226 proceeds to S1103. In S1103, the CPU 226 determines whether the inspection region being the inspection target is the inspection region for which execution of the comparison inspection is selected.

In the case where the CPU 226 determines that the inspection region being the inspection target is not the inspection region for which execution of the comparison inspection is selected (NO in S1103), since the preceding grade inspection is passed and this determines the inspection result, the CPU 226 proceeds to S1106, and determines that the inspection result for the inspection region being the inspection target is “inspection passed”.

In the case where the CPU 226 determines that the inspection region being the inspection target is the inspection region for which execution of the comparison inspection is selected (YES in S1103), the CPU 226 causes the processing to proceed to S1104. In S1104, the CPU 226 executes the comparison inspection on the inspection region being the inspection target. The CPU 226 compares the correct character string that is included in the reference CSV file specified by the user in the registration of the inspection settings and that corresponds to the inspection region being the inspection target with the character string obtained by decoding the inspection region being the inspection target, and determines whether the character strings match each other.

In the case where the CPU 226 determines that the character strings match each other as a result of the comparison inspection (YES in S1104), the comparison inspection is also passed, and the CPU 226 thus proceeds to S1106 and determines that the inspection result for the inspection region being the inspection target is “inspection passed”. Then, the processing of the present flowchart is terminated.

In the case where the CPU 226 determines that the character strings do not match each other as a result of the comparison inspection (NO in S1104), the comparison inspection is failed. Accordingly, the CPU 226 proceeds to S1105, and in S1105, determines that the inspection result for the inspection region being the inspection target is “inspection failed”. Then, the processing of the present flowchart is terminated.

### [Flowchart of Decoding Inspection]

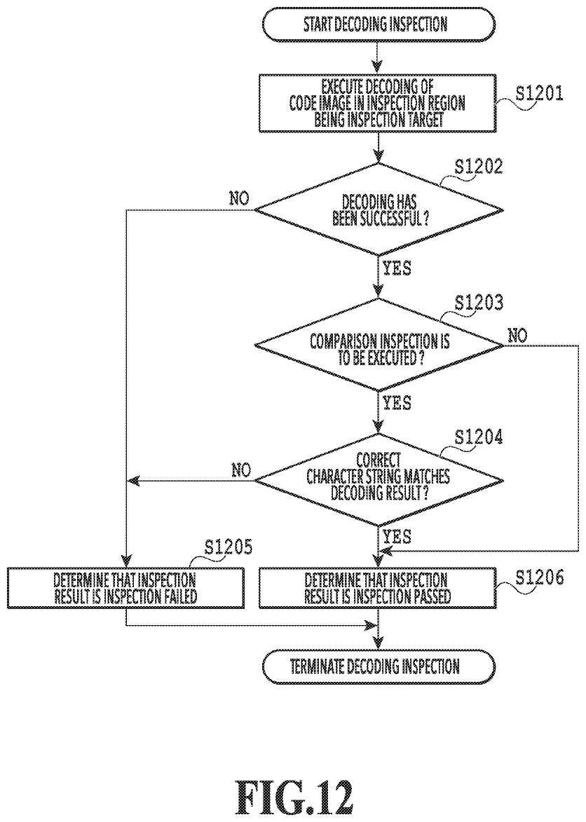

FIG. 12 is a flowchart for explaining details of the decoding inspection executed in S1007 for the inspection region being the inspection target.

In S1201, the CPU 226 decodes the code image included in the inspection region being the inspection target.

In S1202, the CPU 226 determines whether the decoding of the code image included in the inspection region being the inspection target has been successful as a result of S1201.

In the case where the CPU 226 determines that the decoding has failed (NO in S1202), the CPU 226 causes the processing to proceed to S1205, and determines that the inspection result for the inspection region being the inspection target is “inspection failed”. Then, the present flowchart is terminated.

In the case where the decoding of the code image has been successful, the decoding inspection is passed. However, in the case where the comparison inspection is selected to be executed by being included in the decoding inspection, the CPU 226 determines that the inspection result for the inspection region being inspection target is “inspection passed” if the comparison inspection is also passed. Accordingly, in the case where the CPU 226 determines that the decoding of the code image has been successful (YES in S1202), the CPU 226 causes the processing to proceed to S1203, and determines whether the inspection region being the inspection target is the inspection region for which execution of the comparison inspection is selected.

In the case where the CPU 226 determines that the inspection region being the inspection target is not the inspection region for which execution of the comparison inspection is selected (NO in S1203), since the preceding decoding inspection is passed and this determines the inspection result, the CPU 226 proceeds to S1206, and determines that the inspection result for the inspection region being the inspection target is “inspection passed”.

In the case where the CPU 226 determines that the inspection region being the inspection target is the inspection region for which execution of the comparison inspection is selected (YES in S1203), the CPU 226 causes the processing to proceed to S1204. Since S1204 is the same process as S1104, description thereof is omitted.

In the case where the CPU 226 determines that the character strings match each other as a result of the comparison inspection (YES in S1204), the comparison inspection is also passed, and the CPU 226 thus proceeds to S1206 and determines that the inspection result for the inspection region being the inspection target is “inspection passed”. Then, the processing of the present flowchart is terminated.

In the case where the CPU 226 determines that the character strings do not match each other as a result of the comparison inspection (NO in S1204), the comparison inspection is failed. Accordingly, the CPU 226 proceeds to S1205, and determines that the inspection result for the inspection region being the inspection target is “inspection failed”. Then, the processing of the present flowchart is terminated.

As described above, according to the present embodiment, inspection can be performed such that the grade inspection is performed on the code image requiring the grade inspection among the code images, and no grade inspection is performed on the other code images. Accordingly, it is possible to execute required inspection on each inspection region while suppressing a decrease in productivity of print products due to an increase of the inspection time.

Note that description is given assuming that the inspection regions, the inspection contents, and the like included in the inspection settings are registered by being selected by the user through the inspection setting screen 700 in FIG. 7. Alternatively, the inspection region and code type of each code image may be automatically set by being determined from the print job based on image analysis. Moreover, the type of inspection and the like may be automatically set based on rules determined in advance such that the consumed inspection points is 0 or more.

### Second Embodiment

In the grade inspection, the inspection processing is performed for multiple inspection items. In the first embodiment, in the case where the grade inspection is performed, the grade inspection is performed for all inspection items determined in advance. In the present embodiment, description is given of a method in which inspection items for which inspection is to be performed can be selected from among multiple inspection items in the case where the grade inspection is performed. Limiting the inspection items for which inspection is to be performed can suppress the inspection time in the grade inspection. Accordingly, it is possible to increase the inspection regions being targets of the grade inspection and improve the performance of inspection.

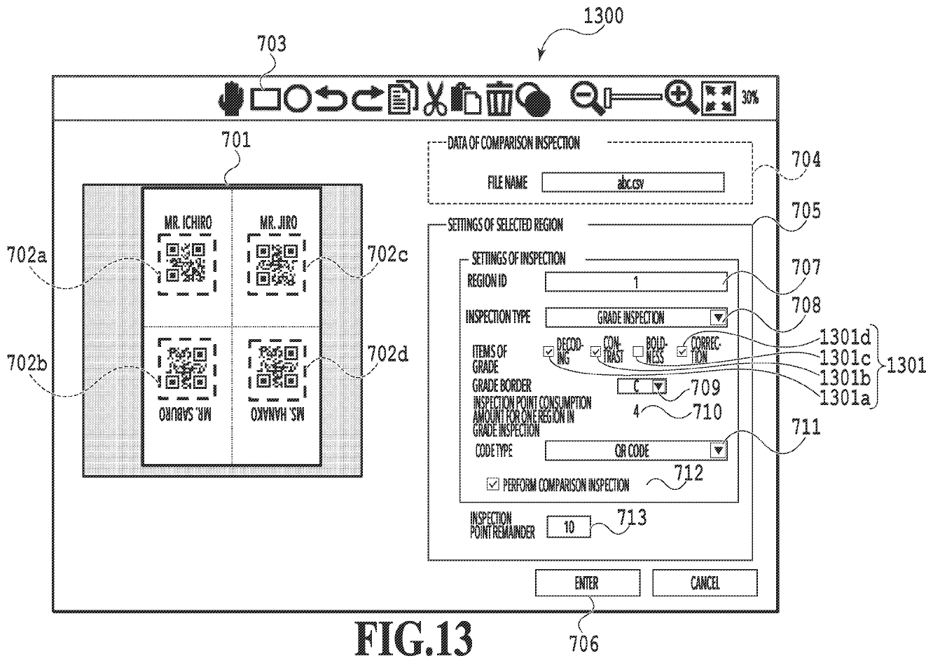

FIG. 13 is a diagram illustrating an example of an inspection setting screen 1300 displayed in the registration processing of the inspection settings in S502 of the present embodiment. Configurations that are the same as those in the inspection setting screen 700 of FIG. 7 are denoted by the same reference numerals, and description thereof is omitted.

The inspection content setting region 705 further includes a check box group 1301 for selecting the inspection items in the grade inspection. The check box group 1301 is formed of check boxes 1301a to 1301d. Each of the check boxes 1301a to 1301d correspond to an inspection item for which the grade is measured in the grade inspection. In the present embodiment, in the case where the grade inspection is selected as the type of inspection, the grades of the inspection items corresponding to checked check boxes among the check boxes 1301a to 1301d are measured. Specifically, the grades of the inspection items corresponding to unchecked check boxes are not measured in the grade inspection even in the case where the grade inspection is selected.

In the case where the check box 1301a is checked, the grade of the inspection item of “decoding” is measured. In the case where the check box 1301b is checked, the grade of the inspection item of “contrast” is measured. In the case where the check box 1301c is checked, the grade of the inspection item of “boldness” is measured. In the case where the check box 1301d is checked, the grade of the inspection item of “correction” is measured.

In FIG. 13, for the inspection region 702a with the region ID of “1”, the check box 1301c corresponding to the inspection item of “boldness” is unchecked. Accordingly, in the case where the grade inspection is performed for the inspection region 702a with the region ID of “1”, the inspection result is inspection passed if the grades of the inspection items of decoding, contrast, and correction are equal to or higher than C that is the grade border.

In the description of FIG. 7, description is given assuming that the consumption amount of the inspection points for the grade inspection in the case where the code type is the two-dimensional code is 5. Specifically, the consumption amount of the inspection points in the case where all of the check boxes 1301a to 1301d are checked is calculated as 5.

Meanwhile, in FIG. 13, the check box 1301c among the check boxes 1301a to 1301d is unchecked. Accordingly, the consumption amount of the inspection points in the grade inspection displayed in the consumed inspection point display region 710 is reduced from 5 to 4. As described above, reducing the inspection items reduces the time required for the inspection, and thus also reduces the consumption amount of the inspection points. The time required for the inspection of the inspection items may be determined by using a table generated in advance, or determined by means such as actual measurement performed by inspecting the registered reference image.

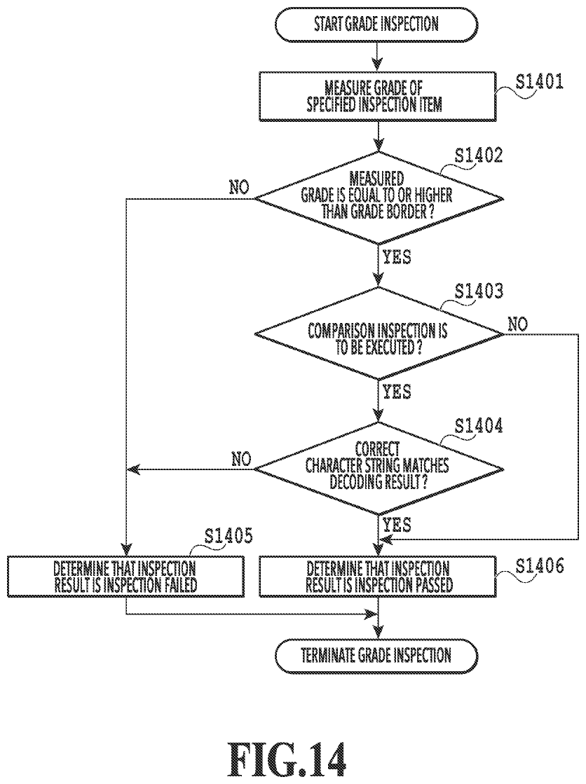

FIG. 14 is a flowchart for explaining details of the grade inspection executed in S1006 of the present embodiment on the inspection region being the inspection target.

In S1401, the CPU 226 measures the grade of each of the inspection items specified in the inspection settings for the code image included in the inspection region being the inspection target.

In S1402, the CPU 226 determines whether the grade with the minimum value among the grades of the respective inspection items specified in the inspection settings is equal to or higher than the grade border. Since S1403 to S1406 are the same processes as S1103 to S1106, description thereof is omitted.

As described above, according to the present embodiment, the grade inspection can be executed such that the grade measurement is performed for the inspection items specified in advance. Selecting the appropriate inspection items for each inspection region can reduce the time required to execute the grade inspection. Accordingly, the number of inspection regions to be targets of the grade inspection can be increased.

According to the present disclosure, the inspection can be efficiently performed also in the case where the print product includes multiple code images.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-021553, filed Feb. 15, 2023, which is hereby incorporated by reference herein in its entirety.

What is claimed is:

1. An inspection apparatus comprising:
a setting unit configured to set a type of inspection to be performed on code images in a print product in which the code images are printed, for each of inspection regions including the code images being inspection targets;
an obtaining unit configured to obtain a read image obtained by reading the print product; and
an inspection unit configured to perform the type of inspection set by the setting unit for each of the inspection regions in the read image, wherein
the type of inspection includes a first type of inspection and a second type of inspection, the second type of inspection including more inspection items than the first type of inspection.

2. The inspection apparatus according to claim 1, wherein
the setting unit sets the type of inspection for each of the inspection regions in advance before the inspection by the inspection unit.

3. The inspection apparatus according to claim 1, wherein the setting unit
obtains information on time usable for the inspection of the read image by the inspection unit and information on inspection time corresponding to the type of inspection, and
performs control of setting the type of inspection based on the information such that the inspection unit is capable of executing the inspection of the read image within the usable time.

4. The inspection apparatus according to claim 3, wherein
the setting unit obtains at least information on inspection time in a case where a code image corresponding to a type of the code image included in the inspection region is inspected in the second type of inspection, as the information on the inspection time corresponding to the type of inspection.

5. The inspection apparatus according to claim 3, wherein the setting unit
obtains the type of inspection selected by a user for each of the inspection regions, and
determines whether the inspection unit is capable of executing the inspection of the read image within the usable time in a case where the inspection is performed in the type of inspection selected by the user, based on the information, and
in a case where the setting unit determines that the inspection unit is capable of executing the inspection within the usable time, sets the type of inspection for each of the inspection regions selected by the user.

6. The inspection apparatus according to claim 5, wherein,
in a case where the setting unit determines that the inspection unit is unable to execute the inspection within the usable time, the setting unit performs control such that the type of inspection selected by the user is not set.

7. The inspection apparatus according to claim 6, wherein,
in a case where the setting unit performs control such that the type of inspection selected by the user is not set, the setting unit displays a predetermined notification on a display unit.

8. The inspection apparatus according to claim 5, further comprising
a display control unit configured to display a screen in which the user selects the type of inspection for each of the inspection regions.

9. The inspection apparatus according to claim 8, wherein
at least the information on the time usable for the inspection of the read image by the inspection unit and the information on the inspection time corresponding to the type of inspection selected by the user are displayed on the screen.

10. The inspection apparatus according to claim 8, further comprising
a registration unit configured to register a reference image that is an image corresponding to the print product, wherein
the setting unit sets regions selected in the reference image displayed on the screen as the inspection regions.

11. The inspection apparatus according to claim 1, wherein
the second type of inspection is a grade inspection in which the code images are inspected by measuring evaluation values of the code images.

12. The inspection apparatus according to claim 11, wherein,
in a case where the grade inspection is set as the type of inspection, the setting unit sets at least one inspection item for which inspection is to be performed in the grade inspection from among a plurality of inspection items.

13. The inspection apparatus according to claim 12, wherein the setting unit
obtains the type of inspection selected by a user for each of the inspection regions, and obtains at least one inspection item selected by the user in a case where the type of inspection selected by the user is the grade inspection,
determines whether the inspection unit is capable of executing the inspection within time usable for the inspection of the read image in a case where the inspection unit performs the inspection in the at least one inspection item selected by the user or the type of inspection selected by the user and
in a case where the setting unit determines that the inspection unit is capable of executing the inspection within the usable time, sets the type of inspection and the at least one inspection item for each of the inspection regions selected by the user.

14. The inspection apparatus according to claim 1, wherein
the first type of inspection is a decoding inspection.

15. An image forming apparatus comprising:
a printing unit configured to generate a print product by printing at least code images on a print medium;
a reading unit configured to generate a read image of the print product by reading the print product; and
a transmission unit configured to transmit the read image to an inspection apparatus to inspect the read image, wherein
the inspection apparatus includes:
a setting unit configured to set a type of inspection to be performed on the code images in the print product in which the code images are printed, for each of inspection regions including the code images being inspection targets;
an obtaining unit configured to obtain the read image obtained by reading the print product; and
an inspection unit configured to perform the type of inspection set by the setting unit for each of the inspection regions in the read image, and
the type of inspection includes a first type of inspection and a second type of inspection, the second type of inspection including more inspection items than the first type of inspection.

16. The image forming apparatus according to claim 15, further comprising:
a conveyance unit configured to convey the print product; and
a reception unit configured to receive an inspection result of the read image corresponding to the print product from the inspection apparatus, wherein
the conveyance unit conveys the print product such that a discharge destination of the print product is switched depending on the inspection result received by the reception unit.

17. A control method comprising:
setting a type of inspection to be performed on code images in a print product in which the code images are printed, for each of inspection regions including the code images being inspection targets;
obtaining a read image obtained by reading the print product; and
performing the set type of inspection for each of the inspection regions in the read image, wherein
the type of inspection includes a first type of inspection and a second type of inspection, the second type of inspection including more inspection items than the first type of inspection.

18. A non-transitory computer-readable storage medium storing a program including instructions, which when executed by a computer, cause the computer to perform a control method comprising:
setting a type of inspection to be performed on code images in a print product in which the code images are printed, for each of inspection regions including the code images being inspection targets;
obtaining a read image obtained by reading the print product; and
performing the set type of inspection for each of the inspection regions in the read image, wherein
the type of inspection includes a first type of inspection and a second type of inspection, the second type of inspection including more inspection items than the first type of inspection.
